(19) United States
(12) Patent Application Publication
(10) Pub. No.: US 2007/0034570 A1
(43) Pub. Date: Feb. 15, 2007

(54) Biofilm reduction in pressure driven membrane-based water treatment systems

(76) Inventor: Felice DiMascio, Rocky Hill, CT (US)

Correspondence Address: CANTOR COLBURN, LLP, 55 GRIFFIN ROAD SOUTH, BLOOMFIELD, CT, 06002, US

(21) Appl. No.: 11/502,778

(22) Filed: Aug. 11, 2006

Related U.S. Application Data
(60) Provisional application No. 60/707,307, filed on Aug. 11, 2005.

(51) Int. Cl. B01D 65/02

(52) U.S. Cl. 210/636; 210/754; 210/650; 210/652

(57) ABSTRACT

A process for reducing and/or eliminating biofilm growth and removal thereof formed during operation of pressure-induced filtration systems such as reverse osmosis systems. The systems and methods are particularly suitable for use with pressure-driven membrane filtration, including microfiltration, ultrafiltration, nanofiltration and reverse osmosis.

### CROSS REFERENCE TO RELATED APPLICATIONS

The present application relates to and claims the benefit of U.S. Provisional Application No. 60/707,307 filed on Aug. 11, 2005, incorporated herein by reference in its entirety.

### BACKGROUND

The present disclosure generally relates to systems and methods for reduction and control of bacterial biofilm, which can form in membrane-based water treatment systems. More particularly, the present disclosure relates to systems and methods for destruction and/or prevention of biofilms in pressure-driven membrane-based water treatment systems.

Pressure-driven membrane systems are used for water treatment in reverse osmosis systems, microfiltration systems, ultrafiltration systems, and nanofiltration systems, among others. Within these types of systems, a decrease in performance because of biofouling continues to be a problem for treatment of many surface waters. For example, in reverse osmosis systems, the thin-film composite (TFC) membrane is prone to biofouling.

Of prime concern in pressure-driven membrane-based water treatment systems is the accumulation and exponential growth of microorganisms, which should not be allowed to grow within the system. Biofilms are generally formed when colonies of bacteria aggregate on surfaces in many different locations. As used herein, the term “biofilm” generally refers to extracellular polymeric substances produced by bacteria along with the bacteria that produce it. For example, when bacteria form an aggregate, they can produce a sugary, polysaccharide-containing mucous coating, or slime. Bacteria grow and multiply faster when attached (sessile) than when free-floating (planktonic). Within the slime, the bacteria form complex communities with intricate architecture including columns, water channels, and mushroom-like towers. These structural details are believed to improve biofilm nutrient uptake and waste elimination.

Biofilms are known to occur is in aqueous systems that use separation membranes, such as in microfiltration, ultrafiltration, nanofiltration and reverse osmosis filtration. Typical membranes used in the above noted systems include, but are not limited to, ceramics, cellulose acetates, polyamides, polyesters, fiberglass, sulfonated polysulfones, acrylonitriles, polyvinylidene fluorides, polycarbonates, polypropylene, polyethylene, polytertrafluoroethylene (PTFE), and the like. For example, microfiltration membranes are typically polymer or pleated cartridge filters rated in the 0.1 to 2 micron range that operate in the 1 to 25 psig pressure range; ultrafiltration is a crossflow process that rejects contaminants (including organics, bacteria, and pyrogens) in the 10 angstrom to 0.1 micron range using operating pressure in the 10 to 100 psig range; nanofiltration equipment removes organic compounds in the 200 to 1,000 molecular weight range, rejecting selected salts; and reverse osmosis removes virtually all organic compounds and 90 to 99% of all ions under pressure in the 200 to 1,000 psig range.

These systems have in common the use of membranes to selectively remove or separate extremely small substances from water and process streams in residential, commercial, and industrial applications. When biofilm is present on the membrane due to microbial growth, colloidal solids and insoluble precipitates can adhere to the sticky substance, thereby deleteriously affecting filtering capability. As this combination builds, water transmission rates through the membrane are reduced and/or additional pressure must be applied to maintain the same water transmission rates. Colloidal solids, microbiological growth, and insoluble precipitates can collect on the membrane during operation.

Also, microorganisms are of major important in any water system. When present, they typically have a negative effect on all functions associated with the use of the water. For example, drinking water contaminated by a pathogenic microorganism can have an adverse effect on human health. Infectious diseases are also known to spread primarily through contaminated water. Therefore, microorganisms require stringent management in all water systems. The pathogenic microorganisms of particular interest in drinking water include, but are not limited to, giardia cysts, legionella pneumophila, enteric viruses, and cryptosporidium.

Conventional treatment methods include continuous dosing, in which a residual level of a biocidal agent is maintained within the system. Intermittent treatment methods include intermittent dosing in which a residual level of a biocidal agent is maintained intermittently within the system. Periodic treatment methods involve the filtration system to be shut down for a periodic cleaning and sanitization using biocidal agent.

With all of the treatment methods, there are some points where the filtration system must be shut down so that the membrane can be cleaned or replaced. This results in downtime and consequent additional operating expense. Moreover, the cleaning and biocidal agents that are conventionally used to clean and sanitize the filtration systems have the effect of degrading the filter membranes, which are typically comprised of polymers such as cellulose acetate or polyamide polymers. A number of pre-treatment processes are also available to reduce the fouling potential of the feed water being introduced to the membrane. These include various types of filtration, disinfection, and chemical treatment. Even with these methods, however, most RO treatment systems must be cleaned regularly.

Typical biocides are chosen to be non-oxidizing and include chlorine, peracetic acid, and dibromonitrilopropionamide. While these biocides can be effective at killing and removing the bacteria for some types of membranes, they may be toxic and may not be approved for drinking water applications, e.g., dibromonitrilopropionamide. Other types of biocides can react with and degrade the membranes used in the water treatment system. For example, although chlorine is approved for drinking water applications and is very effective at removing and killing bacteria, chlorine is known to react with polyamide membranes. Some RO plants still use chlorine, a free halogen, but they have to add a process for the removal of chlorine before the water gets to the membrane. This added step is inconvenient and adds cost.

The above noted pressure based membranes can be used in a variety of applications where biofilm formation is not desirable. These applications generally include water purification systems, food and beverage processing, and waste treatment.

Accordingly, there exists a desired need for improved treatment processes that can achieve reductions in biofilm and/or prevent the formation of biofilm, particularly in the area of aqueous systems that use pressure based separation membranes.

### BRIEF SUMMARY

Disclosed herein are systems and methods for preventing and/or removing biofilm from pressure induced membrane based water treatment systems. In one embodiment, a process for reducing biofilm and/or preventing the formation of the biofilm in a pressurized membrane based water treatment system, comprises contacting the biofilm with a chlorine dioxide solution; and maintaining the chlorine dioxide solution within the water treatment system in an amount effective to prevent formation of the biofilm.

In another embodiment, a process for detecting and preventing biofouling in a reverse osmosis system comprises monitoring a normalized permeate flow of the reverse osmosis system by measuring water temperature, average applied temperature, average feed osmotic pressure, permeate pressure, and actual permeate flow; comparing the normalized permeate flow to a start up normalized permeate flow; and introducing a chlorine dioxide solution into the reverse osmosis system when a percentage difference between the normalized permeate flow and the start up permeate flow is a predetermined percentage, wherein the chlorine dioxide is introduced at a concentration of at least 1 part per million.

The disclosure may be understood more readily by reference to the following detailed description of the various features of the disclosure and the examples included therein.

### BRIEF DESCRIPTION OF THE DRAWINGS

Referring now to the figures wherein the like elements are numbered alike:

FIG. 1 graphically illustrates the percent salt rejection as a function of operation comparing the system with chlorine dioxide solution and without chlorine dioxide solution, wherein the chlorine dioxide solution was introduced after 312 hours of operation; and

FIG. 2 graphically illustrates normalize permeate flow rate as a function of operation comparing the system with chlorine dioxide solution and without chlorine dioxide solution, wherein the chlorine dioxide solution was introduced after 312 hours of operation.

### DETAILED DESCRIPTION

Disclosed herein are processes and systems for preventing and/or reducing the growth of biofilms in pressure driven membrane based water treatment systems. The processes and systems generally include contacting the biofilm with an aqueous chlorine dioxide solution. It has been found that the use of chlorine dioxide can effectively remove previously formed biofilms, can control and/or kill waterborne microorganisms, is compatible with existing membranes, is non-toxic and requires minimal hardware adjustments to existing water treatment systems, is cost effective, and can be made to comply with regulatory requirements at concentrations that are effective to prevent biofilm formation. Chlorine dioxide reacts primarily through oxidation mechanism through its unique one-electron transfer. Chlorine dioxide attacks the electron-rich centers of microorganisms, penetrating the cell wall and reacting with vital amino acids in the cytoplasm of the cell to kill the organism. It is effective at concentrations as low as 0.1 mg/L and over wide pH and temperatures ranges.

Pretreatment of feed water, adequate maintenance of upstream unit operation, continuous flow of water through the RO units, good monitoring and sanitization program, and use of preservatives during downtime are important to this end to prevent and/or minimize the generation of biofilms in addition to the use of chlorine dioxide. Normalized permeate flow and differential pressure in the system are sensitive indicators of biofouling and can be used to alert the end user of potential biofilm problems.

The procedure for biofouling maintenance generally includes recirculation of a biocide through the membrane elements. Treatment is preferably employed before the following performance changes are reached: loss of 10 to 15% in normalized permeate flow rate; increase 10 to 15% in differential pressure; and decrease of 1 to 2% in salt rejection. In the present disclosure, the chlorine dioxide solution can be introduced continuously into the incoming feed water tat a dosage rate equal to the chlorine dioxide demand of the feedwater; continuously inject the chlorine dioxide solution into the concentrate recycle at a dosage rate effective to achieve a constant chlorine dioxide residual of 0.05 to 0.50 milligrams per liter (mg/L); or periodically or intermittently inject the chlorine dioxide solution into the incoming feedwater or concentrate recycle stream at a designated dosage over a designated volume or time, e.g., after every 1000 gallons of water processed with the particular water treatment system, at a dosage rate effective to achieve a 1.0 parts per million (ppm) chlorine dioxide residual for 10 minutes, and the like.

In a preferred embodiment, prevention of biofilm is achieved by a continuous on-line application of very low levels of chlorine dioxide, which permit the membranes to remain in production. Although chlorine dioxide is known to be very effective in destroying microorganisms, it has been discovered to be effective for removing and/or preventing biofilm growth in membrane-based water treatment systems. It reacts primarily through oxidation mechanism through its unique one-electron transfer. Chlorine dioxide attacks the electron-rich centers of microorganisms, penetrating the cell wall and reacting with vital amino acids in the cytoplasm of the cell to kill the organism. It is effective at concentrations as low as 0.1 mg/L and over wide pH and temperatures ranges. Contact with chlorine dioxide provides the system with the ability to remove already formed biofilm; controls waterborne microorganism at very low dosage; is compatible with most membrane polymers; is non-toxic and easily applied; cost effective; and complies with most regulatory requirements

It has been found that if a prior art treatment methods to remove biofilms fail to fully restore the system performance to its start-up values, it is certain that continued use of the same cleaning procedure will lead to accelerated decline in system performance and increasing cleaning frequency. The use of chlorine dioxide overcomes these problems and effectively removes and/or prevents formation of biofilms.

In one embodiment, chlorine dioxide is continuously injected into the incoming feed water at a dosage rate equal to the chlorine dioxide demand of the feed water. In another embodiment, chlorine dioxide is continuously injected into the concentrate recycle at a dosage rate to achieve a 0.1 ppm chlorine dioxide residual. In yet another embodiment, chlorine dioxide is periodically injected into the incoming feed water or concentrate recycle stream at a designated dosage rate over a designated period of volume or time, e.g., after every 1,000 gallons of water processes, inject chlorine dioxide at a dosage rate to achieve a 1.0 ppm chlorine dioxide residual for 10 minutes. In still other embodiments, the treatment is intermittent and is based on water volume from 1 to 1,000,000 gallons in one embodiment, 100 to 100,000 gallons in another embodiment, and most preferably 1,000 to 10,000 gallons and yet another embodiment.

The processes of providing chlorine dioxide is beneficial to numerous applications including, is not limited to, water purification, waster treatment, and liquid processing lines.

Suitable water purification applications include use with boiler feeds, potable from brackish or alkaline source, color removal from surface water, microbial removal; bacteria, pyrogens, giardia and cryptosporidium cysts, THM precursor and pesticide removal, potable from seawater, sodium and organics reduction for beverages, reconstituting food and juices, bottled water, can and bottle rinsing, rinse water for metal finishing operations, spot-free car wash rinses, laboratory and reagent grade water, USP purified water and water for injection, semiconductor chip rinsing, distillation and deionization system pretreatment, kidney dialysis, medical device and packaging rinse water, photographic rinse water, pulp and paper rinses and makeup water, and dye vat makeup water.

Suitable liquid processing line applications include juice and milk concentration, beer and wine finishing, beverage flavor enhancement, cheese whey fractionation/concentration of proteins and lactose, food oils, proteins, taste agents concentration, saccharide purification, maple sap pre-concentration, enzymes and amino acids, purification and concentration, chemical dewatering, chemical mixtures fractionation, dye and ink desalting, glycol and glycerin recovery, ED paint's recovery from rinses, medicine and vitamin concentration purification, blood fractionation, cell broth fractionation, cell concentration, and photographic emulsions concentration/purification.

Suitable waste treatment applications tertiary sewage water recovery, heavy metals and plating salts concentration, de-watering liquid for reduced disposal volume, dilute materials recovery, radioactive materials recovery, textile waste recovery for reuse, pulp and paper water recovery for reuse, dye and ink concentration and recovery, photographic waste concentration and recovery, oil field “produced water” treatment, lubricants concentration for reuse, commercial laundry water and heat reuse, and end of pipe treatment for water recovery.

By using chlorine dioxide, the effectiveness and operating lifetimes of pressure-driven membrane filtration systems are obtained, particularly reverse osmosis systems, by increasing throughput, maintaining or improving efficiency, reducing biofilm, decreasing periodic maintenance requirements, and decreasing the need for costly system shutdowns with the use of chlorine dioxide.

Advantageously, the addition of chlorine dioxide to the treatment system can provide a chlorine dioxide residual in the permeate. The benefits of having a chlorine dioxide residual in the permeate will prevent microbiological recontamination by the downstream piping or storage systems. By way of example, chlorine dioxide can be injected into the feed water at a concentration such that it passes through the membrane and into the permeate at a controlled concentration. The concentration of chlorine dioxide injected into the feed water is a function of the characteristics of the membrane, operating parameters and degree of microbiological growth (fouling).

In one embodiment, a chlorine dioxide solution containing 40 to 99%, more preferably 60 to 99%, and most preferably 90 to 99% chlorine dioxide is employed. In another embodiment, the method of chlorine dioxide injection is periodic, more preferably intermittent, and most preferably continuous. The frequency of injection for intermittent treatment can be time based, e.g., from 0.01 to 8,760 hours, more preferably 0.1 to 730 hours, and most preferably 1 to 24 hours. Intermittent treatment can also be based on water volume, from 1 to 1,000,000 gallons, more preferably 100 to 100,000 gallons, and most preferably 1,000 to 10,000 gallons. Similarly, periodic treatment where the frequency of shutdown is from 24 to 8,760 hours, more preferably 168 to 4,380 hours, and most preferably 730 to 2,190 hours can be employed.

The chlorine dioxide residual in the feed water to the water treatment system is preferably from 0 to 5 ppm, more preferably 0 to 1 ppm, most preferably 0 to 0.1 ppm. Injection of chlorine dioxide can occur in the concentrate recycle stream or in the incoming feed water stream. The chlorine dioxide process is suitable for use with various membrane types including, but not limited to, ceramic, cellulose acetate, polyamide polymers, polyester, fiberglass, sulfonated polysulfone, acrylonitrile, polyvinylidene fluoride, polycarbonate, polypropylene, polyethylene, and polytetrafluoroethylene (PTFE).

In one embodiment, chlorine dioxide is applied in a pressure-driven membrane separation process such that chlorine dioxide passes through the membrane and into the permeate, wherein the chlorine dioxide has a residual concentration of chlorine dioxide from 0 to 1 ppm, more preferably 0.3 to 0.9 ppm, most preferably 0.5 to 0.8 ppm.

To determine the effectiveness of chlorine dioxide in destroying and/or preventing biofouling, various parameters can be monitored in a pressure based membrane water treatment system. Using a reverse osmosis (RO) system as an example, these parameters can include first stage pressure differential, second stage pressure differential feed concentration, reject concentration, normalized permeate flow, permeate concentration, percent recovery, and slat rejection.

As the feed water passes through the pressure vessels of an RO unit, it encounters resistance due to the feed spacers in the membrane elements. Therefore, even new elements present some resistance to flow as the water passes through the system. As the membrane elements experience use, foulants will build up on the surface of the membrane and in the feed spacer material itself. As these foulants accumulate, the resistance to flow of the feed water increases. This resistance to flow may be measured as a differential pressure across the vessel.

Differential pressures, in pounds per square inch (psi), are easy to calculate using the following equation (I):
ΔP=P_{f}−Pᵣ (I)
where ΔP is the differential pressure, P_{f} is the feed pressure (vessel inlet), and Pᵣ is the reject pressure (vessel outlet).

In most RO systems there is more than one vessel in the array. Since the vessels are all piped into a single header on both the inlet and outlet, these pressures can be monitored on the header resulting in one feed pressure and one reject pressure per array. Many RO systems also have more than one array or stage. In this case, pressure can be monitored at three or more locations and the differential pressures calculated by the following equations:
ΔP₁=P_{f}−Pᵢ (II), and
ΔP₂=Pᵢ−Pᵣ (III)
where ΔP₁ is the differential pressure across the first stage, ΔP₂ is the differential pressure across the second stage, and Pᵢ is the interstage pressure (i.e., between vessels).

As in the case of most RO parameters, it is important to monitor the change in differential pressure over time. As foulants build up on the membrane surface and in the channels of the feed spacer, the differential pressure will increase. It is important to act promptly if the differential pressure begins to increase. If the differential pressure is allowed to increase excessively, structural damage to the membrane elements is likely to occur. It is also more difficult to clean the membrane elements if they have acquired a high differential pressure since differential pressure restricts flow. Remember, the cleaning solution will have to flow through the same restricted feed channels as the feed water. In multi-stage systems it is advantageous to observe the change in differential pressure relative to the stage. If the first stage shows a high differential pressure relative to the second stage, it may mean that the fouling is due to suspended solids being caught in the front end of the flow path. If the second stage shows a high differential pressure relative to the first stage, it may be an indication of scaling taking place in the second stage.

The parameter, “recovery” generally refers to the amount of permeate being produced by the RO relative to the amount of feed water. It can be calculated with the following equation (IV):

$$\% R = ( \frac{{F}_{p}}{{F}_{f}} ) \times 100 \qquad ( IV )$$

where % R is percent recovery, Fₚ is the permeate flow rate, and F_{f} is the feed flow rate.

The parameter “concentration” can be related to conductivity by the following equation (V):
Concentration (mg/l)=Conductivity(μS)×0.67 (V)

One of the most popular methods of calculating salt rejection is the feed-reject average method, which can be calculated using the following equation (VI).

$$\% SR = 100 - ( \frac{2 {C}_{p}}{( {C}_{f} + Cr )} ) \times 100 \qquad ( VI )$$

where % SR is the percent salt rejection, Cₚ is the concentration of dissolved solids in permeate, C_{f} is the concentration of dissolved solids in feed water, and Cᵣ is the concentration of dissolved solids in reject.

Many RO operators mistakenly use actual permeate flow to indicate RO performance. While this may be effective in some cases, it is usually not a good idea. Actual permeate flow from a give RO unit is a function of three different variables. These are: 1) Net Drive Pressure, 2) Water Temperature, and 3) Membrane Condition. With regard to biofouling, the membrane condition is of most interest. A change in membrane condition would indicate such things as fouling, scaling, and chemical attack. If the first two variables were to stay constant, a decline in actual permeate flow would indicate a change in membrane condition. Unfortunately, this is seldom the case in practice. Rather, other variables can change. When they do, a change in actual permeate flow may no longer mean a change in RO performance. Even worse, RO performance may be changing (i.e., membrane fouling or damage may be occurring) although no change in actual permeate flow is seen.

Calculating normalized permeate flow simply means that changes that occur in the first two variables are considered. If a change in permeate flow is still observed after accounting for any changes in net drive pressure and water temperature (by calculating normalized permeate flow) and, then this change is believed to be due to the third variable (i.e., the membrane condition). In other words, a change in membrane condition is occurring or has occurred and requires attention, i.e., usually this means the membrane must be cleaned.

As noted above, the first two variables that affect permeate flow are net drive pressure and water temperature. Net Drive Pressure (NDP) refers to the summation of four different pressures acting upon the RO membrane during operation of an RO system. Two of these pressures are positive and two are negative. The four pressures are summarized below:
Applied Pressure—This is the largest of the two positive pressures making up NDP. Applied pressure is created by the high-pressure pump supplying feed water to the RO membrane. Without applied pressure, reverse osmosis is not possible.
Osmotic Pressure of Permeate—The osmotic pressure of the permeate is the second of the two positive pressures making up NDP. Since the permeate is very low in dissolved solids, the osmotic pressure of the permeate is very low. For this reason, it is often left out of the NDP calculation.
Osmotic Pressure of the Feed Water—The osmotic pressure of the feed water is usually the largest of the two negative components of the NDP. It is a function of the amount of dissolved solids in the feed water and may be approximated by the following equation (VII):
   Osmotic Pressure (psi)=Total Dissolved Solids (mg/l)/100 (VII)

Actual permeate pressure (APP) is the second of the two negative components of NDP. Actual permeate pressure is the back pressure placed upon the permeate during RO operation. It is usually a result of back pressure placed upon the permeate by a control valve or hydrostatic pressure from an overhead permeate tank. In some cases, there may be no permeate pressure.

The NDP is calculated with the following equation (VIII):
NDP=Pₐ+Pₒₚ−P_{of}−Pₚ (VIII)
where Pₐ is the applied pressure, Pₒₚ is the osmotic pressure of permeate, P_{of} is the osmotic pressure of feed water, and Pₚ is the permeate pressure.

Since the osmotic pressure of the permeate is usually very low, it is often left out of the NDP equation resulting in the following equation (IX):
NDP=Pₐ−P_{of}−Pₚ (IX)

The above equation describes the NDP at only one spot in the RO system. In reality, there are an infinite number of NDP's in the RO system from feed water inlet to concentrate outlet. This is due to the fact that the applied pressure decreases as the feed water progresses from the inlet to the outlet. This pressure decrease results from the pressure drop across the feed spacer as the water flows through the membrane elements. Likewise, the osmotic pressure of the feed water increases as the water flows from the feed water inlet to the concentrate outlet. This is due to the increase in feed water total dissolved solids (TDS) as permeate passes through membrane. Since these pressures change from the feed water inlet to the concentrate outlet, it is necessary to take the average of the applied pressure and the feed water osmotic pressure across the RO unit. Using these average values in the NDP equation results in the average net drive pressure. It is the average NDP that is used in the calculation of normalized permeate flow.

Water temperature has an effect on the amount of water which is permeated through a given amount of membrane under a given net drive pressure. As its temperature drops, water becomes slightly more viscous and more difficult to force through the membrane. Likewise, as the temperature increases, water is more easily forced through the membrane.

These changes in permeate flow due to temperature changes in the feed water do not indicate problems with the membrane. They do, however, need to be taken into consideration when calculating normalized permeate flow. This is done by using a temperature correction factor (TCF). These factors are determined experimentally by the membrane manufacturer and are used in the normalized permeate flow calculation to account for changes in permeate flow due to changes in temperature. Table 3 includes some typical temperature correction factors. Please note, however, that each type of membrane will have a different set of temperature correction factors as provided by equation (X):
TCF=−0.0411T+2.0321 (X)
where T is the feed water temperature (° C.).

Normalized permeate flow may be calculated by means of the following equation (XI):

$$NPF = \frac{{( NDP )}_{s}}{{( NDP )}_{a}} \times TCF \times {F}_{p} \qquad ( XI )$$

where (NDP)ₛ is the net drive pressure at standard conditions (start up conditions are often used as standard conditions), (NDP)ₐ is the net drive pressure at actual conditions, TCF is the Temperature Correction Factor for Actual Temperature, and Fₚ is the actual permeate flow rate.

As an example, NPF values can be calculated using the information listed in Table 1. In this example, we will be using start up data as our standard.

TABLE 1
RO Operating Data

| | Date | |
|---|---|---|
| | January 2001 | August 2001 |
| Feed Water Temperature, ° C. | 21 | 29 |
| TCF | 1.172 | 0.857 |
| Average Applied Pressure, psi | 195 | 205 |
| Average Feed Osmotic Pressure, psi | 50 | 45 |
| Permeate Pressure, psi | 15 | 15 |
| Actual Permeate Flow, gpm | 25 | 25 |

NPF at start up can be calculated as follows
(NDP)ₛ=Pₐ−P_{of}−Pₚ=195 psi−50 psi−15 psi=130 psi

$$NPF = \frac{130 {psi}^{*}}{130 psi} \times 1.172 \times 25 gpm = 29 gpm$$

By calculating the NPF at start up, both NDP's in this equation are the same. Actual NPF can be calculated as follows.
(NDP)ₛ=205 psi −45 psi−15 psi=145 psi

$$NPF = \frac{130 psi}{145 psi} \times 0.857 \times 25 gpm = 19 gpm$$

A vast difference is observed between the two NPF values, 29 gpm versus 19 gpm. This indicates that the membrane condition has changed over the first few months of operation. If the RO operator had been using the actual permeate flow rate as an indicator of performance, this change in membrane condition would not have been noticed. However, by normalizing the permeate flow, changes that have occurred over the months have been accounted for in NDP and water temperature. By comparing the two normalized permeate flows, we can clearly see that a change in membrane condition has also occurred.

In our example, a dramatic change in membrane condition is readily discerned after an operating time period of several months. From this example, it should be clear to one skilled in the art that that normalized permeate flow is desirably calculated more often than every few months. Had the NPF in our example been calculated more frequently (possibly once per day), a gradual downward trend in NPF would have been noticed. It is this gradual downward trend in NPF that indicates the onset of membrane fouling or scaling. If remedies are not taken, the rate of NPF decline becomes greater. If the NPF drops too far, irreparable membrane damage will likely be the result.

In order to measure the decline in NPF, a reference point is needed. This reference point is the amount of permeate flow expected from the NDP and temperature to which the permeate flow is being normalized (usually start up or standard conditions). If modern thin film composite membranes are being used, the expected permeate flow does not change very significantly from that experienced within a few days after start up, e.g., at time zero to about 100 hours of operation. Normalizing the data to these start up conditions and comparing NPF to the start up NPF has been found to be suitable for monitoring most RO systems using thin film composite membrane. Cellulose acetate (CA) membrane poses a slightly different situation. CA membrane exhibits a normal flux decline over time due to membrane compaction. When normalizing permeate flow from CA membrane it may be necessary to take this normal flux decline into effect. The membrane manufacturer can provide assistance in determining the normal flux decline for a given type of membrane.

As the condition of the membrane declines, the NPF drops below the curve showing the expected permeate flow. When the NPF drops to approximately 15% below that expected, the membrane is cleaned and NPF once again returns to match the expected permeate flow. If, after cleaning, the NPF does not return to the expected curve, it is likely that the cleaning was not effective or the membrane may be damaged and may need to be replaced.

### EXAMPLES

In this example, two reverse osmosis systems were mounted onto a skid. The reverse osmosis systems included a Koch 2.4 by 40-inch brackish water membrane. One system was used as a control whereas the other system was further modified to include plumbing for introducing a chlorine dioxide solution into the recirculation and/or feed lines. A chlorine dioxide solution at a concentration of about 500 mg/L was used.

A Halox (Bridgeport, Conn.) Accu-Cide system with a 5 gallon dosage system was used to generate and store chlorine dioxide solution at a concentration of approximately 500 mg/L. The evaluation was conducted with the following parameters recorded. Absolute measurements of flow rates were taken using a graduated cylinder and stopwatch. Conductivity measurements were taken using a Myron-L conductivity meter. Temperatures were taken using a thermometer. Installed pressure gauges were used to obtain pressure values. A Halox Accu-Meter chlorine dioxide colorimeter (DPD/Glycine) was used to measure chlorine dioxide residuals. After recording the raw data listed above, two calculated values were prepared using the raw data collected from the reverse osmosis system.

Both systems were operated with feed water only for a brief conditioning period. The incoming feed water was treated by a water softener for hardness removal and carbon filtration for chlorine removal prior to the reverse osmosis system. The feed water temperature began at approximately 9° C. and steadily increased to approximately 22° C. during the 5,000 hours of operation. The conductivity of the feed water was approximately 120 microsiemens. The differential pressure across the one stage in the systems was kept constant at 150 psi throughout the evaluation. The recirculation rate was approximately 6 liter per minute (1 pm).

After 288 hours, the chlorine dioxide solution was introduced into the recirculation line. The flow capacity of the metering pump was approximately 4.87 gallons per day (gpd) at 150 psi. A Pulsafeeder (Punta Gorda, Fla.) Vision Model UV controller was configured to energize the metering pump for 10 seconds after every 5 gallons of feed water passed.

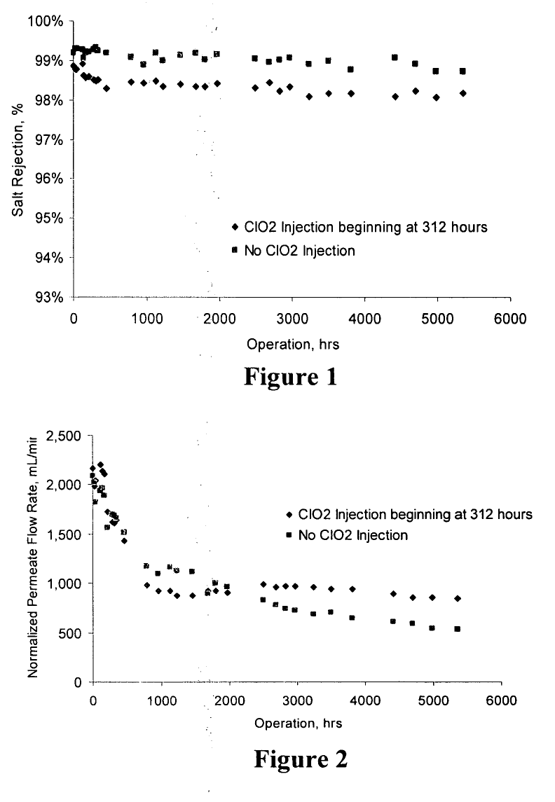

The measured chlorine dioxide residual in the recirculation line was approximately 0.38 mg/L. The water recovery in both systems was approximately 87%. The membrane was not able to prevent passage of chlorine dioxide. A chlorine dioxide residual in the permeate was measured, progressively increasing from zero to 0.06 mg/L after 5,000 hours of operation. A comparison of performance between the control and chlorine dioxide injection systems is presented in FIGS. 1 and 2.

FIG. 1 illustrates a steady salt rejection for the control (99.1%) and chlorine dioxide injected systems (98.4%) after 5,000 hours of operation. In FIG. 2, the control system showed a progressive decrease through the same time period. Reduction in normalized permeate flow rate is an indication of biofouling. It appears that the chlorine dioxide solution prevented biofilm formation and maintained membrane production when compared to the control.

While the disclosure has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A process for reducing biofilm and/or preventing the formation of the biofilm in the vicinity of a membrane used in a pressurized membrane based water treatment system, the process comprising:
contacting the biofilm with a chlorine dioxide solution, wherein the chlorine dioxide is at a concentration of at least 0.1 milligrams per liter; and
maintaining the chlorine dioxide solution within the water treatment system in an amount effective to prevent formation of the biofilm.

2. The process of claim 1, wherein the chlorine dioxide solution recirculates through the membrane and into a permeate.

3. The process of claim 1, wherein the chlorine dioxide solution is introduced intermittently based on a predetermined volume of water processed in the water treatment system.

4. The process of claim 1, wherein the chlorine dioxide solution is at a concentration effective to provide a residual chlorine dioxide concentration in a permeate downstream from the membrane of at least 1 part per million.

5. The process of claim 1, wherein the water treatment system is a selected one of a reverse osmosis system, a microfiltration system, a nanofiltration system, and an ultrafiltration system.

6. The process of claim 1, wherein the membrane is selected from a group consisting of ceramic, cellulose acetate, polyamide, polyester, fiberglass, sulfonated polysulfone, acrylonitrile, polyvinylidene fluoride, polycarbonate, polypropylene, polyethylene, and polytetrafluoroethylene.

7. A process for detecting and preventing biofouling in a reverse osmosis system, the process comprising:
monitoring a normalized permeate flow of the reverse osmosis system by measuring water temperature, average applied temperature, average feed osmotic pressure, permeate pressure, and actual permeate flow;
comparing the normalized permeate flow to a start up normalized permeate flow; and
introducing a chlorine dioxide solution into the reverse osmosis system when a percentage difference between the normalized permeate flow and the start up permeate flow is a predetermined percentage, wherein the chlorine dioxide is introduced at a concentration of at least 1 part per million.

8. The process of claim 7, wherein the percentage difference between the normalized permeate flow and the start up permeate flow is greater than 15%.

9. The process of claim 7, wherein the membrane is selected from a group consisting of ceramic, cellulose acetate, polyamide, polyester, fiberglass, sulfonated polysulfone, acrylonitrile, polyvinylidene fluoride, polycarbonate, polypropylene, polyethylene, and polytetrafluoroethylene.

10. The process of claim 7, wherein the chlorine dioxide solution is at a concentration effective to provide a residual chlorine dioxide concentration in a permeate downstream from the membrane of less than 1 part per million.

11. The process of claim 7, further comprising applying a normal flux decline to the normal permeate flow to account for compaction of the membrane.

12. The process of claim 7, wherein the chlorine dioxide solution is at a concentration effective to provide a residual chlorine dioxide concentration in a permeate downstream from the membrane of at least 1 part per million.

13. The process of claim 7, wherein the start up normalized permeate flow rate is determined at time zero to about 100 hours of operation.

14. The process of claim 7, wherein the percentage difference between the normalized permeate flow and the startup permeate flow decreases after introducing the chlorine dioxide solution.
